(19) United States
(12) Patent Application Publication
(10) Pub. No.: US 2024/0101586 A1
(43) Pub. Date: Mar. 28, 2024

(54) PYRIDINE PYRROLE RUTHENIUM COORDINATION COMPLEX, PREPARATION METHOD THEREFOR AND USE THEREOF AS CATALYST FOR ELECTROCATALYZING AMMONIA OXIDATION TO PREPARE HYDRAZINE

(71) Applicant: CENTRAL SOUTH UNIVERSITY, Changsha (CN)

(72) Inventors: Xiaoyi YI, Changsha (CN); Guo CHEN, Changsha (CN)

(73) Assignee: CENTRAL SOUTH UNIVERSITY, Changsha (CN)

(21) Appl. No.: 18/272,369

(22) PCT Filed: Dec. 15, 2022
(86) PCT No.: PCT/CN2022/139184

§ 371 Date: Jul. 14, 2023

(30) Foreign Application Priority Data
Dec. 22, 2021 (CN) 202111584527.X

(51) Int. Cl. C07F 15/00; B01J 31/22

(52) U.S. Cl. CPC C07F 15/0053; B01J 31/22

(57) ABSTRACT

A pyridine pyrrole ruthenium coordination complex, a preparation method therefor and use thereof as a catalyst for electrocatalyzing ammonia oxidation to prepare hydrazine is provided. The pyridine pyrrole ruthenium coordination complex takes high-activity metal ruthenium as a central metal ion and compounds containing pyridine pyrrole with electron withdrawing/donating capability as ligands, and thus has relatively high catalytic activity for ammonia oxidation. High conversion rate and highly selective conversion of ammonia can be realized by applying the pyridine pyrrole ruthenium coordination complex to electrocatalytic ammonia oxidation in an organic solvent, with major products including H₂, N₂, N₂H₄.

### CROSS REFERENCE TO RELATED APPLICATIONS

This application is the national phase entry of International Application No. PCT/CN2022/139184, filed on Dec. 15, 2022, which is based upon and claims priority to Chinese Patent Application No. 202111584527.X, filed on Dec. 22, 2021, the entire contents of which are incorporated herein by reference.

### TECHNICAL FIELD

The present invention belongs to the technical field of catalysis and relates to a catalytic material, particularly to a pyridine pyrrole ruthenium coordination complex catalytic material, and also to a synthesis method therefor and use thereof as a catalyst for electrocatalyzing ammonia oxidation to prepare hydrazine.

### BACKGROUND

Hydrogen (H₂) is one of the most ideal substitutes for fossil fuels; however, the large-scale direct use of hydrogen energy is limited by its disadvantages of very low volumetric energy density, being highly inflammable and explosive, high storage and transportation costs, and poor safety, and the like. Therefore, it is imperative to develop hydrogen storage technology and hydrogen storage materials. Among many hydrogen storage materials, liquid small molecules are attracting attention as hydrogen energy carriers. Ammonia molecule (NH₃) has a hydrogen content as high as 17.6 wt % and thus has a big advantage as a hydrogen energy carrier, but its development and utilization progress slowly, mainly because it is mainly limited by the half-reaction of ammonia oxidation. Using small molecule metal coordination complexes as homogeneous catalysts provides a solution for catalytic oxidation of ammonia molecules under mild conditions.

Hydrazine (N₂H₄) is widely applied in the fields of chemical industry, aerospace and energy as a strongly reducing, high-energy chemical reagent. In 1907, the industrial production of N₂H₄ was realized for the first time, and after more than 100 years of development, the current industrial production of N₂H₄ still relies on the traditional or improved Raschig method, which uses a strongly oxidizing agent to chemically oxidize NH₃ to prepare N₂H₄, and still faces many bottleneck problems.

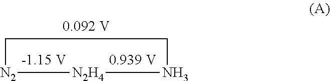

1) Low conversion rate and low product concentration in the reaction system. Since the dehydrogenation conversion of NH₃ to N₂H₄ is very thermodynamically unfavorable (E^{Θ} N₂H₄/NH₃=0.939 V) (as shown in (a)), the conversion of NH₃ to N₂H₄ in the conventional process is inefficient (<10%). Therefore, the molar ratio of NH₃/N₂H₄ is usually increased (>40/1) to improve the conversion rate. This leads to a low N₂H₄ product concentration (<8%) in the reaction system and thus to a long, highly energy-consuming industrial process of subsequently extracting and concentrating hydrazine hydrate (N₂H₄·H₂O).

2) Environmental pollution and many by-products. The traditional Raschig method uses a large amount of chlorine-containing strong oxidants, causing environmental pollution. The improved Raschig method also produces a large amount of organic by-products.

3) High cost of preparing anhydrous N₂H₄. The added value of anhydrous N₂H₄ is much higher than that of hydrazine hydrate (N₂H₄·H₂O), as anhydrous N₂H₄ is 450,000 yuan/ton and 80% N₂H₄·H₂O is 25,000 yuan/ton. Performing the Raschig method in an aqueous solution usually only affords up to 80% hydrazine hydrate (N₂H₄·H₂O), and costly dehydration processes are required to obtain anhydrous N₂H₄.

In a word, since the scientific challenge that the dehydrogenation conversion of NH₃ to N₂H₄ is very thermodynamically unfavorable have not been overcome for a long time, the problem that the existing process for preparing N₂H₄ is complicated, produces low yield, is highly energy-consuming, and so on, cannot be addressed, keeping the price of N₂H₄ high. Therefore, developing a high-efficiency new method for preparing anhydrous N₂H₄ is scientifically challenging and is also of great practical value.

In an organic solvent, the electrocatalytic NH₃ oxidation can realize the co-production of two products of high added value in one step: anhydrous N₂H₄ and H₂. The process has up to 100% atom economy and is cost-effective, and the industrial process is short; it is expected to become a disruptive and innovative technical approach to preparing anhydrous N₂H₄. Therefore, it is of great theoretical significance and practical value to develop a catalyst for electrocatalyzing ammonia oxidation to prepare hydrazine.

### SUMMARY

To solve the problems in the prior art, a first aim of the present invention is to provide a pyridine pyrrole metal ruthenium coordination complex having high catalytic activity for electrocatalytic ammonia oxidation.

A second aim of the present invention is to provide a simple and convenient method for preparing the pyridine pyrrole metal ruthenium coordination complex at low cost.

A third aim of the present invention is to provide use of the pyridine pyrrole ruthenium coordination complex as a catalyst for electrocatalyzing ammonia oxidation. The pyridine pyrrole ruthenium coordination complex has high catalytic activity for electrocatalytic ammonia oxidation, and can convert ammonia into H₂, N₂ and N₂H₄ with high efficiency and high selectivity.

To achieve the above aims, the present invention provides a pyridine pyrrole ruthenium coordination complex, which has any one of structures of Formula 1 to Formula 5:

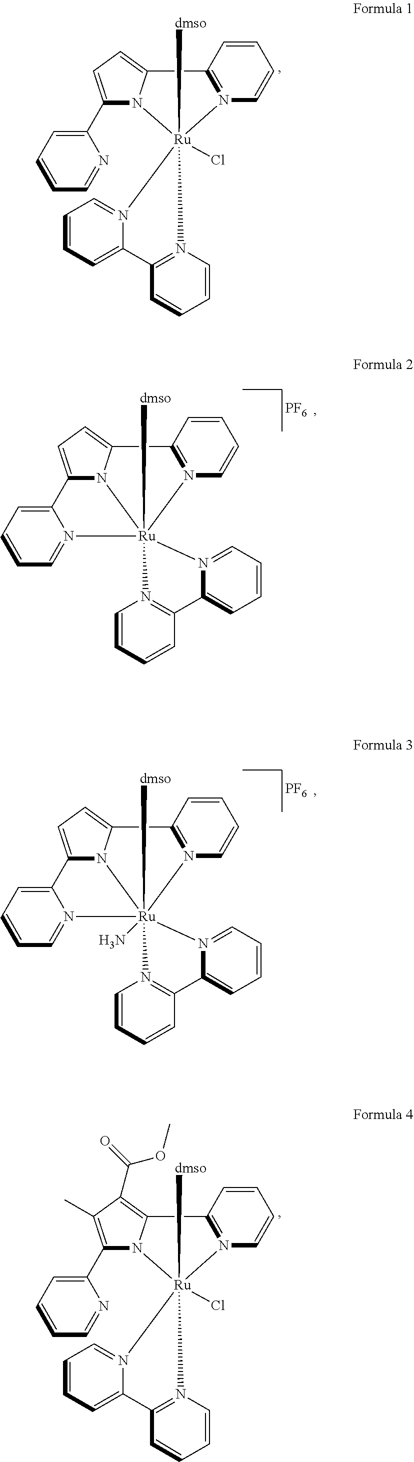

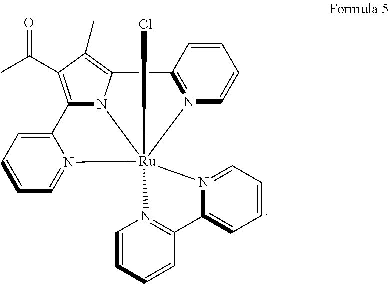

The pyridine pyrrole ruthenium coordination complex of the present invention takes metal ruthenium as a central metal ion, and pyridine pyrrole compounds as ligands. The metal ruthenium is a high-period transition metal, having various oxidation states (the valence ranges from −2 to +8) and showing high reaction activity. The pyridine pyrrole ligands have electron withdrawing/donating capability and can effectively reduce the potential of ammonia oxidation. Meanwhile, the internal hydrogen bond formed by a pyridine group of the pyridine pyrrole ligands and an ammonia molecule can accelerate the deprotonation process in ammonia oxidation, so that the whole pyridine pyrrole ruthenium coordination complex has high catalytic activity and high selectivity for ammonia oxidation.

The present invention also provides a method for synthesizing the pyridine pyrrole ruthenium coordination complex, which comprises the following steps:
1) dissolving 2,5-dipyridylpyrrole, 2,5-dipyridyl-3-methyl-4-acetylpyrrole or 2,5-dipyridyl-3-carboxymethyl-4-methylpyrrole, cis-dichlorotetrakis(dimethyl sulfoxide)ruthenium, bipyridine and a basic compound in an organic solvent, and heating the resulting solution at reflux for reaction to obtain the pyridine pyrrole ruthenium coordination complex having a structure of Formula 1, Formula 4 or Formula 5;
2) dissolving the pyridine pyrrole ruthenium coordination complex having a structure of formula 1 in a solvent, firstly heating the resulting solution at reflux for reaction, and then adding saturated ammonium hexafluorophosphate for ion exchange to obtain the pyridine pyrrole ruthenium coordination complex having a structure of Formula 2; and
3) dissolving the pyridine pyrrole ruthenium coordination complex having a structure of formula 2 in a solvent, and then introducing an ammonia-containing gas for reaction to obtain the pyridine pyrrole ruthenium coordination complex having a structure of Formula 3.

As a preferred embodiment, a molar ratio of 2,5-dipyridylpyrrole, 2,5-dipyridyl-3-methyl-4-acetylpyrrole or 2,5-dipyridyl-3-carboxymethyl-4-methylpyrrole to cis-dichlorotetrakis(dimethyl sulfoxide)ruthenium is 1:2 to 2:1.

As a preferred embodiment, a molar ratio of cis-dichlorotetrakis(dimethyl sulfoxide)ruthenium to bipyridine is 1:3 to 3:1.

As a preferred embodiment, the basic compound is at least one of calcium hydride, sodium hydride and triethylamine. These basic compounds are mainly used to promote the deprotonation reaction of 2,5-dipyridylpyrrole, 2,5-dipyridyl-3-methyl-4-acetylpyrrole or 2,5-dipyridyl-3-carboxymethyl-4-methylpyrrole. The basic compounds and the pyridine pyrrole ligands are used in a ratio of (1-8):1.

As a preferred embodiment, basic compounds that promote deprotonation reaction can be used, for example: sodium, sodium bicarbonate, sodium carbonate, sodium methoxide, and sodium hydroxide.

As a preferred embodiment, in step (1), the reaction is performed at a temperature of 50-115° C. for a period of 8-12 h.

As a preferred embodiment, in step 1), the organic solvent is dichloromethane, trichloromethane, acetonitrile, methanol, tetrahydrofuran, benzene or toluene.

As a preferred embodiment, in step (2), the reflux reaction is performed at a temperature of 50-115° C. for a period of 2-6 d.

As a preferred embodiment, the ammonia-containing gas has an ammonia concentration of greater than 1%. The ammonia-containing gas may be pure ammonia gas or a combination of ammonia gas and nitrogen gas or an inert gas.

The present invention also provides use of the pyridine pyrrole ruthenium coordination complex as a catalyst for electrocatalyzing ammonia oxidation to prepare N₂H₄ and simultaneously co-produce H₂.

The method for preparing the pyridine pyrrole ruthenium coordination complex provided by the present invention is specifically as follows:

(1) Any one of 2,5-dipyridylpyrrole, 2,5-dipyridyl-3-methyl-4-acetylpyrrole and 2,5-dipyridyl-3-carboxymethyl-4-methylpyrrole ligands, and dichlorotetrakis(dimethyl sulfoxide)ruthenium, bipyridine and a basic compound are dissolved in a solvent such as toluene, methanol or tetrahydrofuran under nitrogen atmosphere, and the resulting solution was magnetically stirred and heated at reflux for 8-12 h.

(2) After the reaction is completed, solvents such as toluene, diethyl ether or water are each added under nitrogen atmosphere to wash the mixture three times. Subsequently, the resulting solid is dissolved in dichloromethane, and anhydrous sodium sulfate is added to remove water from the solution. The solvent is removed from the filtrate to obtain a red solid, which is the ruthenium coordination complex having a structure of Formula 1, Formula 4 or Formula 5.

(3) The pyridine pyrrole ruthenium coordination complex having a structure of formula 1 is dissolved in a solvent such as toluene, methanol or tetrahydrofuran under nitrogen atmosphere, and the resulting solution is stirred, and heated at reflux for 2-6 d.

(4) A saturated aqueous ammonium hexafluorophosphate solution is added dropwise to the above solution. After 2 h of stirring, the reaction mixture is filtered and dried by rotary evaporation to obtain a yellow solid, which is the pyridine pyrrole ruthenium coordination complex having a structure of Formula 2.

(5) The pyridine pyrrole ruthenium coordination complex having a structure of Formula 2 is dissolved in a solvent such as trichloromethane and dichloromethane or tetrahydrofuran and acetonitrile, and an ammonia gas with the concentration of 1-99.9% is then introduced for more than half an hour. The solution is left to stand for at least two days to obtain a red solid, which is the pyridine pyrrole ruthenium coordination complex having a structure of Formula 3.

The pyridine pyrrole ruthenium coordination complexes having structures of formula 1 to formula 5 of the present invention all have the catalytic property of electrocatalyzing ammonia oxidation to produce H₂, N₂ and N₂H₄. For example, electrolysis at a potential of no less than 0.5 V vs. Cp₂Fe^{+/0} for 0-72 h under argon atmosphere produces 0-2500 μmol H₂, 0-25 μmol N₂ and 0-2500 μmol N₂H₄. The conversion rate of converting NH₃ into N₂H₄ may be up to 45%, and the solubility of N₂H₄ in the electrolysis solution reaches 0.032 mol/L, with high Faraday efficiency FE of 50-92%.

Compared with the prior art, the technical solutions of the present invention have the following beneficial technical effects:

1) The pyridine pyrrole ruthenium coordination complexes of the present invention take high-activity metal ruthenium as a central metal ion and pyridine pyrrole compounds with electron withdrawing/donating capability as ligands, and thus have relatively high catalytic activity for ammonia oxidation. The method for preparing the pyridine pyrrole ruthenium coordination complexes of the present invention is simple, convenient and cost-efficient, favoring large-scale production.

2) The pyridine pyrrole ruthenium coordination complexes of the present invention can realize a one-step method for preparing anhydrous N₂H₄ and simultaneously co-producing H₂ by electrocatalytic NH₃ oxidation with high selectivity (n_{N2H4}/n_{N2max} 200), high catalytic efficiency (TOF_{N2H4max} 400 h⁻¹) and high Faraday efficiency FEₘₐₓ 92%.

3) The pyridine pyrrole ruthenium coordination complexes of the present invention can realize a one-step method for preparing N₂H₄ in a pure organic solvent, favoring separation and purification.

4) To date, the synthesis of N₂H₄ still uses the traditional Raschig method and a non-catalytic oxidation approach. The approach uses a complicated process, produces low yield, is highly energy-consuming, and cause serious pollution. The pyridine pyrrole ruthenium coordination complexes of the present invention electrocatalyze the oxidation reaction at only room temperature and atmospheric pressure to synthesize two products of great value in one step, and the separation procedure is very simple. The present invention is completely capable of providing disruptive and innovative technology for the industrial production of anhydrous N₂H₄ in the future.

### BRIEF DESCRIPTION OF THE DRAWINGS

FIG. 1 is a single crystal diffraction pattern of coordination complex 1 [Ru(K²—N,N′-dpp)(bpy)(S-dmso)(Cl)];

FIG. 2 is a single crystal diffraction pattern of coordination complex 2 [Ru(K³—N,N′N″-dpp)(bpy)(S-dmso)]·PF₆;

FIG. 3 is a single crystal diffraction pattern of coordination complex 3 [Ru(K²—N,N′-dpp)(bpy)(S-dmso)(NH₃)]·PF₆;

FIG. 4 is a single crystal diffraction pattern of coordination complex 4 [Ru(K²—N,N′-mdpc)(bpy)(S-dmso)(Cl)];

FIG. 5 is a single crystal diffraction pattern of coordination complex 5 [Ru(K³—N,N′N″-mdpe)(bpy)(Cl)];

FIGS. 6A-6B are graphs showing standard curves of gas chromatography of hydrogen and nitrogen;

FIG. 7 is a graph showing the gas composition during ammonia oxidation reactions electrocatalyzed by 0.01 mM coordination complexes 1, 2 and 3;

FIGS. 8A-8D are graphs showing the gas composition during an ammonia oxidation reaction electrocatalyzed by 0.01 mM coordination complex 3 at various reaction times;

FIGS. 9A-9D are graphs showing the gas composition during an ammonia oxidation reaction electrocatalyzed by 0.01 mM coordination complex 5 at various reaction times;

FIGS. 10A-10B are graphs showing ultraviolet-visible spectrum absorption intensity and hydrazine concentration standard curves;

FIG. 11 is a graph showing ultraviolet-visible absorption spectra of the electrolysis solutions of coordination complexes 1, 2, and 3 after reacting with p-C₉H₁₁NO for 1 h.

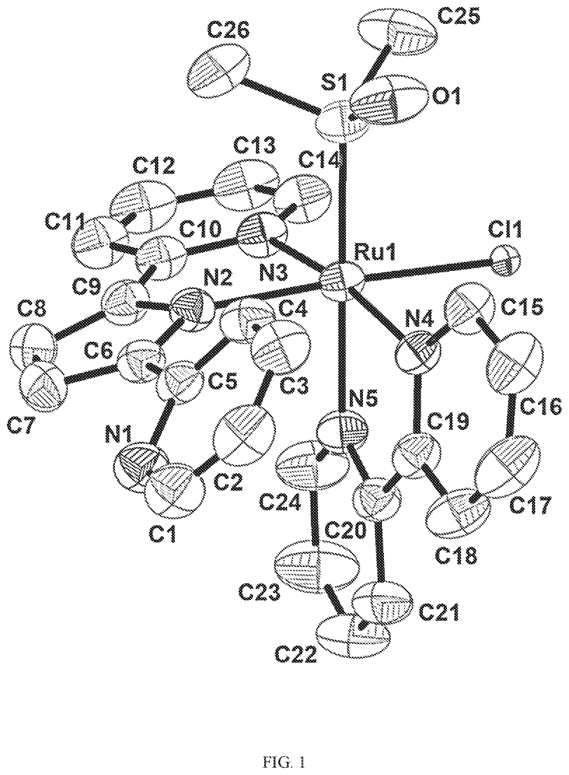

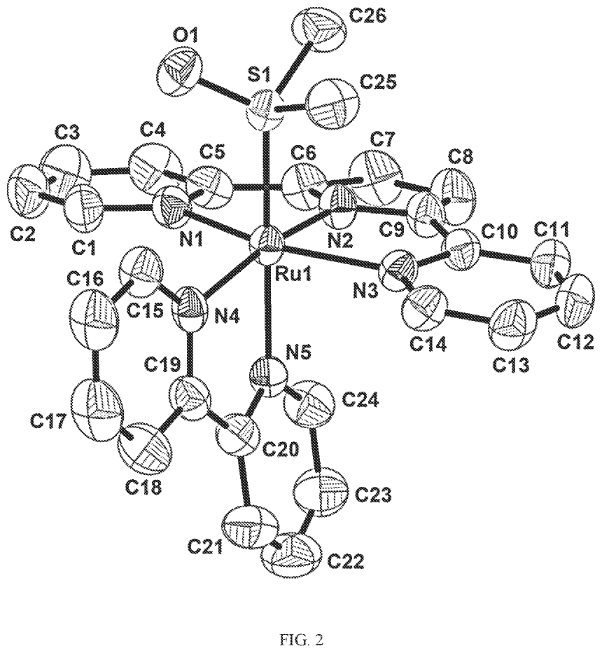

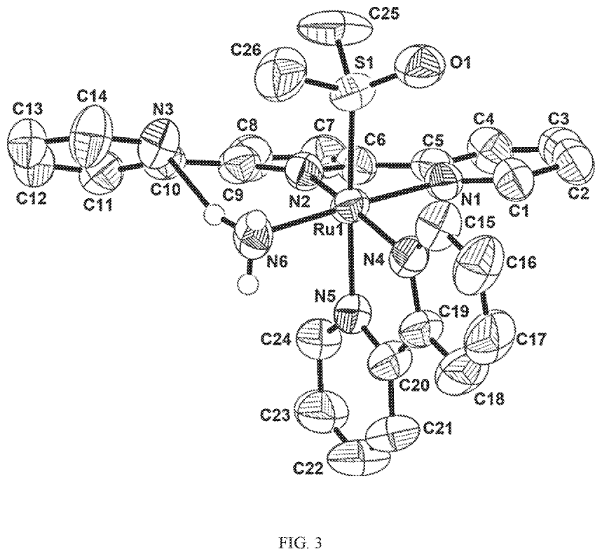

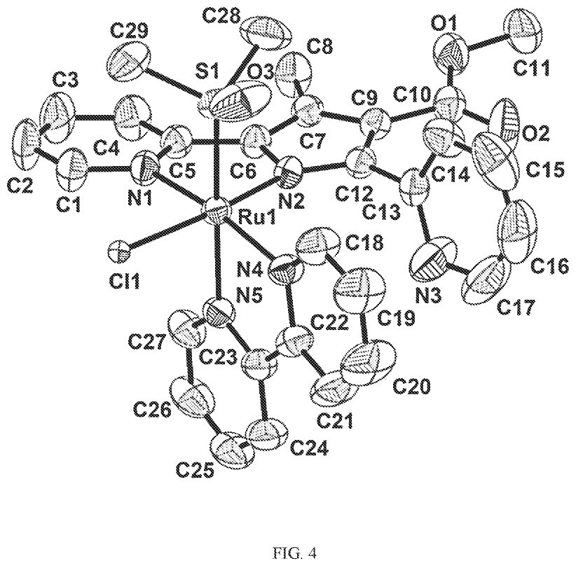

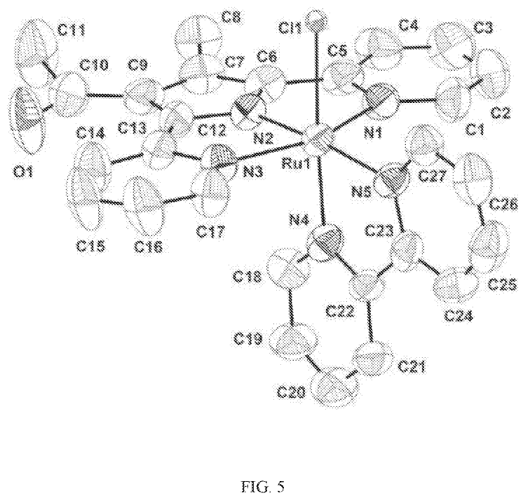

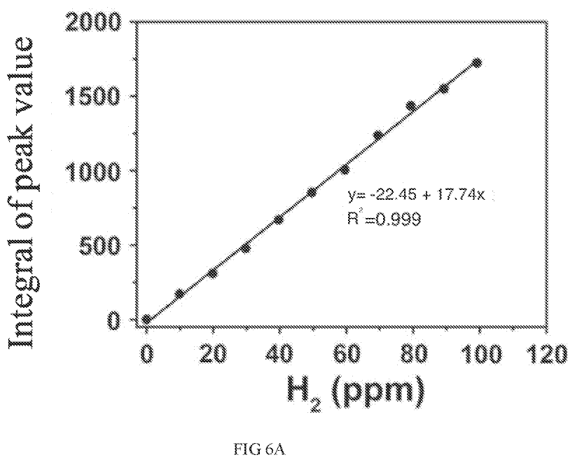

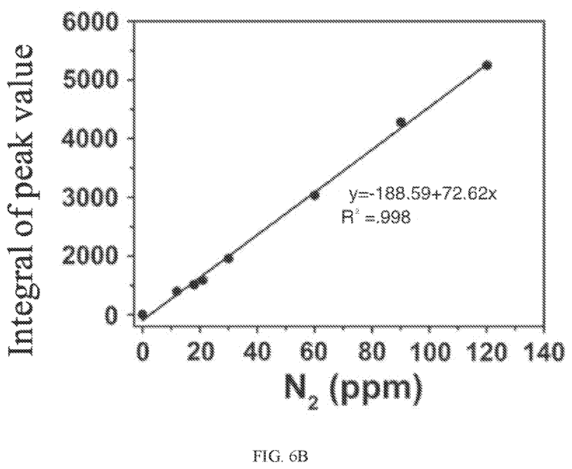

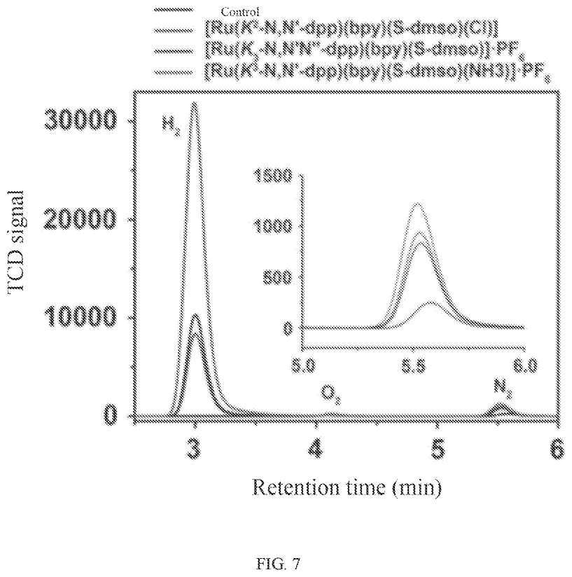

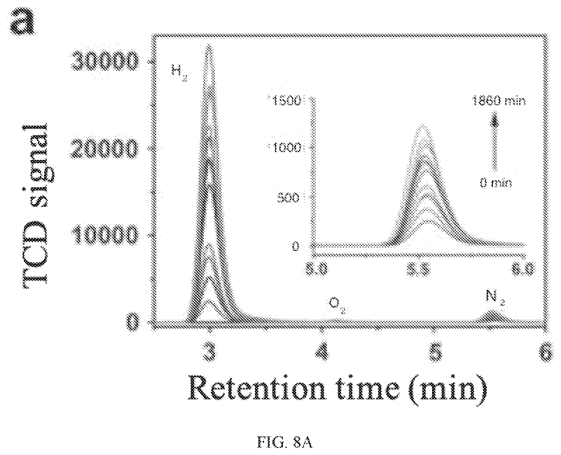

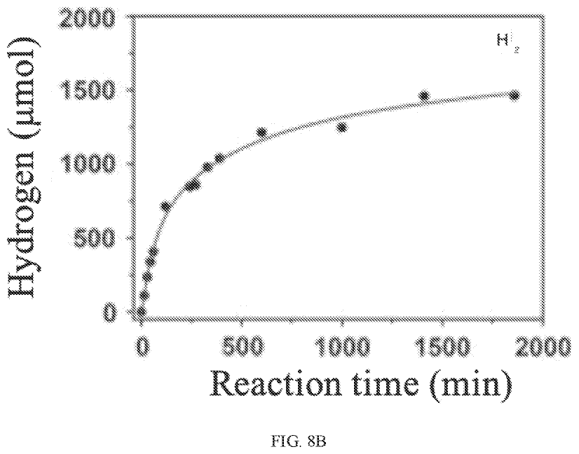

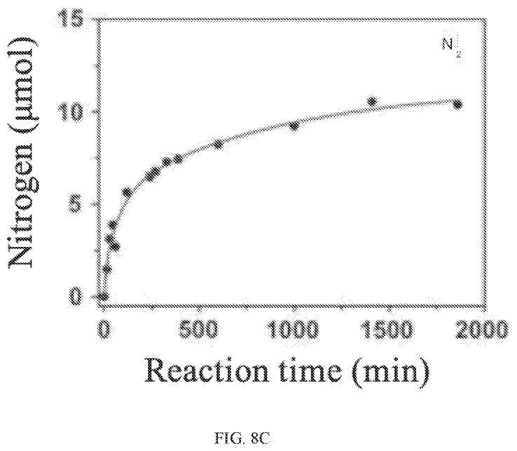

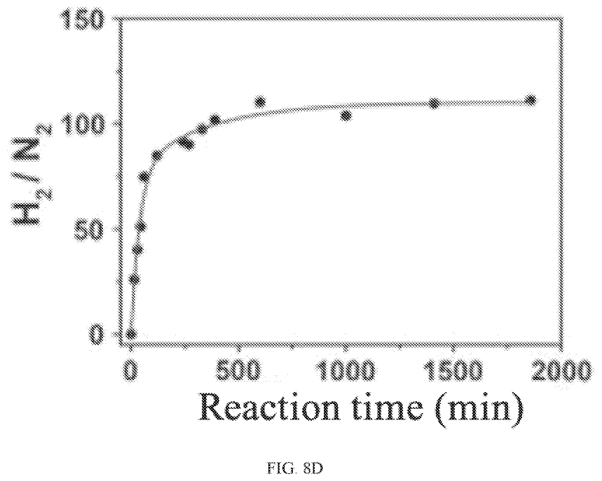

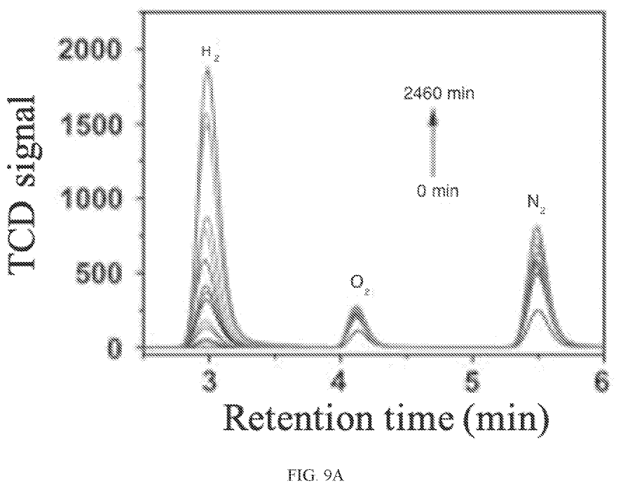

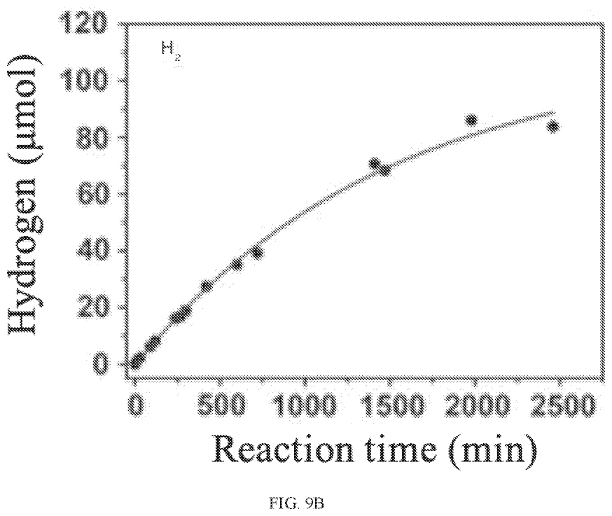

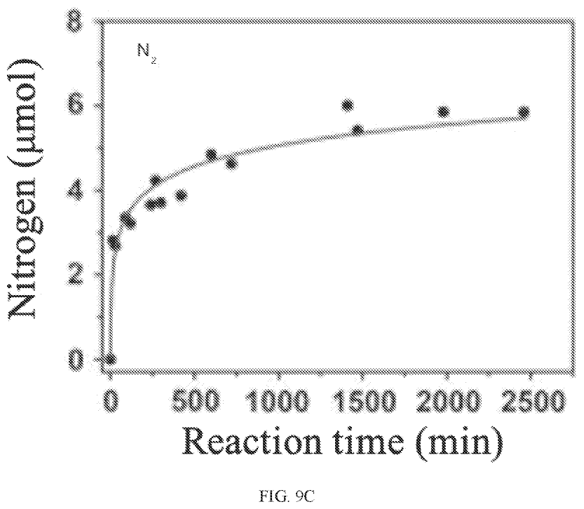

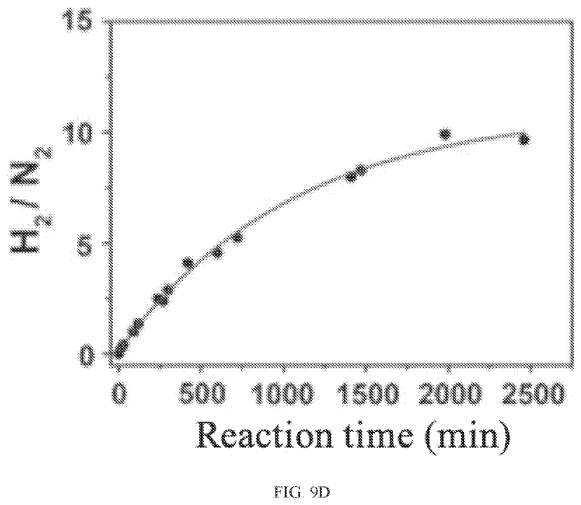

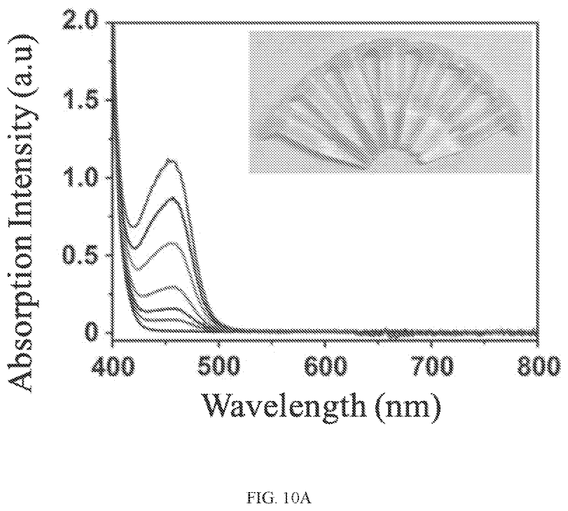

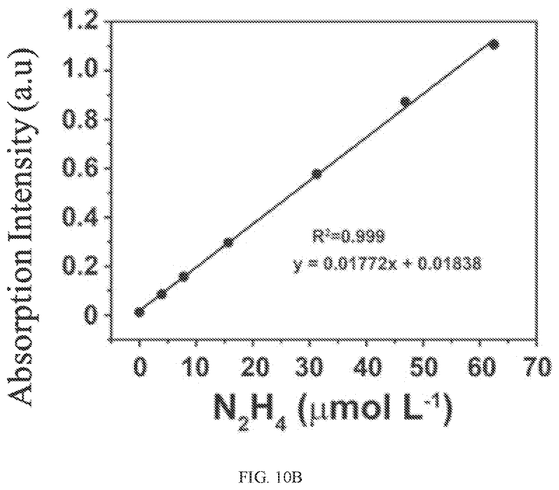

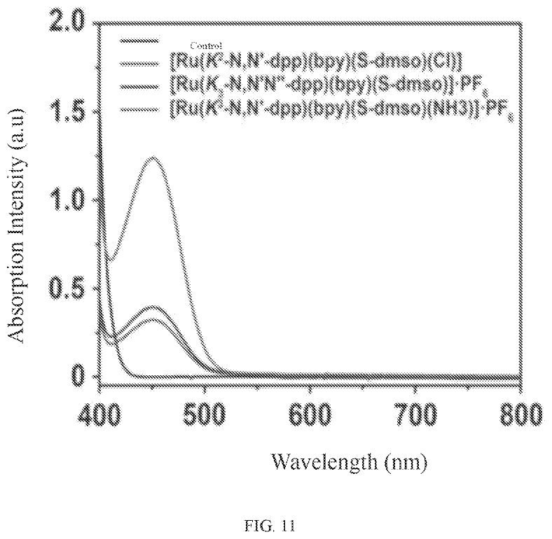

### DETAILED DESCRIPTION OF THE INVENTION

To facilitate the understanding of the present invention, the present invention will be described comprehensively and in further detail with reference to preferred examples. However, the protection scope of the present invention is not limited to the following specific examples.

The substrate starting materials, solvents, etc. involved in the following examples are all commercially available products (analytically pure reagents). All the reagents used had underwent purification, drying and oxygen removal pretreatments. The involved synthesis and treatment processes used standard anhydrous and oxygen-free treatment techniques. ¹H NMR, ³¹P NMR, and ¹⁹F NMR used CDCl₃ as solvent and TMS as internal standard.

Multiplicity is defined as follows: s (singlet); d (doublet); t (triplet); q (quartet) and m (multiplet). Absorption intensity is defined as follows: s (strong absorption); m (moderate absorption); w (weak absorption).

Unless defined otherwise, all the terms used in the following have the same meaning as commonly understood by those skilled in the art. The terms used herein are for the purpose of describing specific examples only and not all of them are within the scope of the present invention.

### Example 1

### 1. Preparation of Coordination Complex 1 [Ru(K²—N,N′-dpp)(bpy)(S-dmso)(Cl)]

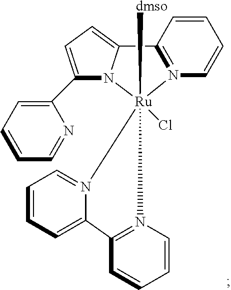

(1) cis-Dichlorotetrakis(dimethyl sulfoxide)ruthenium (1.088 g, 2.248 mmol), 2,5-dipyridylpyrrole (0.566 g, 2.248 mmol), bipyridine (0.351 g, 2.247 mmol) and triethylamine were dissolved in an organic solvent (50 mL) under nitrogen atmosphere. The solution was magnetically stirred and heated to 105° C. and was reacted for 10 h.

(2) After the reaction was completed, toluene, diethyl ether and water were each added under nitrogen atmosphere to wash the mixture three times. Subsequently, the resulting solid was dissolved in dichloromethane, and anhydrous sodium sulfate was added to remove water was removed from the solution. The solvent was removed from the filtrate to obtain a red solid.

(3) The resulting red solid was dissolved in dichloromethane by liquid phase diffusion, and diethyl ether and n-hexane were sequentially added. After the mixture was left to stand for 2 weeks, coordination complex 1 was obtained as a red acicular crystal.

Yield: 32%

¹H NMR (400 MHz, CDCl₃): δ10.171-10.186 (d, 1H), δ9.399-9.413 (d, 1H), δ8.125-8.137 (d, 1H), δ7.914-7.934 (d, 1H), δ7.644-7.731 (m, 3H), δ7.573-7.607 (t, 2H), δ7.472-7.510 (m, 1H), δ7.099-7.169 (m, 4H), δ6.963-6.995 (m, 1H), δ6.829-6.838 (d, 1H), δ6.676-6.710 (m, 1H), δ6.299-6.309 (d, 1H), δ3.165 (s, 3H), δ2.401 (s, 3H) ppm.

IR (KBr, cm⁻¹): 1589 (s), 1522 (s), 1433 (s), 1323 (s), 1279 (w), 1152 (w), 1074 (s), 1014 (s), 961 (w), 919 (w), 789 (m), 766 (s), 724 (m), 686 (m), 435 (m).

### 2. Preparation of Coordination Complex 2 [Ru(K³—N,N′N″-dpp)(bpy)(S-dmso)]·PF₆

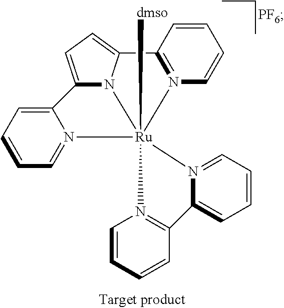

(4) Coordination complex 1 was dissolved in an organic solvent under nitrogen atmosphere. The solution was stirred and heated to 60° C., reacted for 4 days, and then concentrated to 3 mL by rotary evaporation.

(5) A saturated aqueous ammonium hexafluorophosphate solution was added dropwise to the above solution. After 2 h of stirring, the reaction mixture was filtered and dried by rotary evaporation to obtain a yellow solid.

(6) The resulting red solid was dissolved in dichloromethane by liquid phase diffusion, and diethyl ether and n-hexane were sequentially added. After the mixture was left to stand for 2 weeks, coordination complex 2 was obtained as a red acicular crystal.

Yield: 93%.

¹H NMR (400 MHz, CDCl₃): δ10.315-10.301 (d, 1H), δ8.583-8.563 (d, 1H), δ8.442-8.422 (d, 1H), δ8.177-8.138 (t, 1H), δ7.924-7.884 (t, 1H), δ7.763-7.730 (t, 1H), δ7.550-7.511 (m, 2H), δ7.418-7.399 (d, 2H), δ7.328-7.315 (d, 2H), δ7.231-7.197 (t, 1H), δ6.909 (s, 2H), δ6.823-6.809 (d, 1H), δ6.748-6.715 (m, 2H), δ2.582 (s, 6H) ppm.

³¹P NMR (162 MHz, CDCl₃): δ−135.60, 6-140.01, 6-144.40, 6-148.80, 6-153.20 ppm.

¹⁹F NMR (380 MHz, CDCl₃): δ−72.36, δ−74.25 ppm.

IR (KBr, cm⁻¹): 1598 (s), 1486 (s), 1396 (m), 1298 (s), 1263 (w), 1156 (w), 1087 (m), 1042 (w), 1008 (m), 840 (s), 760 (s), 557 (s), 431 (m).

TABLE 1
Crystal data of coordination complex 2

| Compound | Coordination complex 2 |
|---|---|
| Empirical formula | C₂₆H₂₄F₆N₅OPRuS |
| Formula weight | 700.60 |
| Crystal system | monoclinic |
| Space group | P2₁/n |
| a/Å | 9.52761(19) |
| b/Å | 26.2603(5) |
| c/Å | 12.0967(2) |
| a/° | |
| b/° | 101.4548(16) |
| g/° | |
| V/[Å³] | 2966.28(10) |
| Z | 4 |
| ρ_{calcd} [g cm⁻³] | 1.569 |
| u [mm−¹] | 0.719 |
| F(000) | 1408.0 |
| Rᵢₙₜ | 0.0384 |
| ^{a}GooF | 1.024 |
| ^{b}R₁, ^{c}wR₂ [I > 2σ (I)] | 0.0406/0.0898 |
| R₁, wR₂ [all data] | 0.0615/0.0968 |

^{a}GOOF = [Σw(|Fₒ| − |F_{c}|)²/(N_{obs} − Nₚₐᵣₐₘ)]^{1/2}.
^{b}R₁ = Σ||Fₒ| − |F_{c}||/Σ|Fₒ|.
^{c}wR₂[(Σw|Fₒ| − |F_{c}|)²/Σw²|Fₒ|²]^{1/2}.

TABLE 2
Some bond length and bond angle data of coordination complex 2
Bond Distances(Å)

| | | | |
|---|---|---|---|
| Ru(1)—N(1) | 2.1371(19) | Ru(1)—N(5) | 2.1002(19) |
| Ru(1)—N(2) | 1.9368(17) | Ru(1)—S(1) | 2.2310(6) |
| Ru(1)—N(3) | 2.1341(17) | S(1)—O(1) | 1.4823(17) |
| Ru(1)—N(4) | 2.1037(17) | | |

Bond Angles (°)

| | | | |
|---|---|---|---|
| N(1)—Ru(1)—N(2) | 76.22(7) | N(3)—Ru(1)—N(5) | 84.61(7) |
| N(1)—Ru(1)—N(3) | 152.48(7) | N(4)—Ru(1)—N(5) | 77.58(7) |
| N(1)—Ru(1)—N(4) | 102.97(7) | S(1)—Ru(1)—N(1) | 91.80(5) |
| N(1)—Ru(1)—N(5) | 92.43(7) | S(1)—Ru(1)—N(2) | 92.53(6) |
| N(2)—Ru(1)—N(3) | 76.55(7) | S(1)—Ru(1)—N(3) | 93.28(5) |
| N(2)—Ru(1)—N(4) | 169.54(8) | S(1)—Ru(1)—N(4) | 97.93(6) |
| N(2)—Ru(1)—N(5) | 92.00(8) | S(1)—Ru(1)—N(5) | 174.42(5) |
| N(3)—Ru(1)—N(4) | 103.07(7) | O(1)—S(1)—Ru(1) | 118.20(8) |

### 3. Preparation of Coordination Complex 3 [Ru(K²—N,N′-dpp)(bpy)(S-dmso)(NH₃)]·PF₆

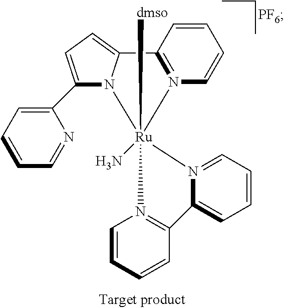

(1) Coordination complex 2 (35 mg, 0.050 mmol) was dissolved in trichloromethane. Then 2% ammonia gas was introduced (nitrogen as carrier gas) for half an hour, and the solution was left to stand for 1 h. The process was repeated 3 times. The solution was left to stand for 2 weeks and finally concentrated at room temperature. Diethyl ether and n-hexane were sequentially added, and coordination complex 3 was obtained as a red lamellar crystal by liquid phase diffusion.

Yield: 98%.

¹H NMR (400 MHz, CDCl₃): δ9.871-9.858 (d, 1H), δ8.412-8.401 (d, 1H), δ8.313-8.293 (d, 1H), δ8.251-8.231 (d, 1H), δ7.714-7.675 (t, 1H), δ7.646-7.612 (t, 1H), δ7.517-7.503 (d, 1H), δ7.463-7.402 (m, 2H), δ7.328-7.315 (d, 2H), δ7.189-7.175 (d, 1H), δ7.095-7.175 (d, 1H), δ7.095-7.064 (m, 1H), δ7.029-7.019 (d, 1H), δ6.981-6.952 (t, 1H), δ6.617-6.586 (t, 1H), δ3.160 (s, 3H), δ3.110 (s, 3H), δ2.534 (s, 3H) ppm.

³¹P NMR (162 MHz, CDCl₃): δ−135.92, 6-140.28, 6-144.64, 6-149.00, 6-153.36 ppm.

¹⁹F NMR (380 MHz, CDCl₃): δ−72.02, δ−73.89 ppm.

IR (KBr, cm⁻¹): 3371 (w), 1604 (m), 1529 (m), 1454 (w), 1421 (m), 1325 (m), 1161 (w), 1080 (m), 1018 (m), 843 (s), 764 (m), 685 (w), 557 (m), 430 (m).

### 4. Preparation of Coordination Complex 4 [Ru(K²—N,N′-mdpc)(bpy)(S-dmso)(Cl)] Target Product

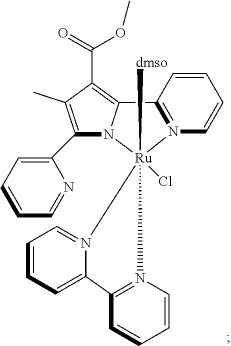

(1) Dichlorotetrakis(dimethyl sulfoxide)ruthenium (1.088 g, 2.248 mmol), 2,5-dipyridyl-3-carboxymethyl-4-methylpyrrole ligand (0.659 g, 2.248 mmol), bipyridine (0.351 g, 2.247 mmol) and triethylamine were dissolved in an organic solvent (50 mL) under nitrogen atmosphere. The solution was stirred and heated to 105° C. and was reacted for reaction for 9 h.

(2) After the reaction was completed, diethyl ether and water were each added under nitrogen atmosphere to wash the mixture three times. Subsequently, the resulting solid was dissolved in dichloromethane, and anhydrous sodium sulfate was added to remove water from the solution. The solvent was removed from the filtrate to obtain a red solid.

(3) The red solid was separated by column chromatography on a chromatographic silica gel column to obtain a red solid product.

(4) The resulting red solid was dissolved in dichloromethane by liquid phase diffusion, and diethyl ether and n-hexane were sequentially added. After the mixture was left to stand for 2 weeks, coordination complex 4 was obtained as a red acicular crystal.

Yield: 25%.

¹H NMR (400 MHz, CDCl₃): δ9.677-9.689 (d, 1H), δ9.552-9.565 (d, 1H), δ8.045-8.091 (t, 2H), δ7.847-7.868 (d, 2H), δ7.738-7.796 (m, 2H), δ7.485-7.528 (m, 1H), δ7.430-7.442 (d, 1H), δ7.132-7.178 (m, 2H), δ7.026-7.062 (m, 1H), δ6.892-6.928 (m, 1H), δ6.779-6.813 (m, 1H), δ6.724 (s, 1H), δ3.290 (s, 3H), δ3.019 (s, 3H) ppm, δ2.744 (s, 3H) ppm, δ2.460 (s, 3H) ppm.

IR (KBr, cm⁻¹): 3603 (m), 2916 (s), 2497 (m), 1682 (s), 1589 (m), 1521 (w), 1444 (s), 1414 (w), 1323 (w), 1261 (w), 1198 (w), 1153 (w), 1078 (s), 1012 (w), 766 (s), 729 (w), 679 (w), 430 (m).

### 5. Preparation of Coordination Complex 5 [Ru(K³—N,N′N″-mdpe)(bpy)(Cl)] Target Product

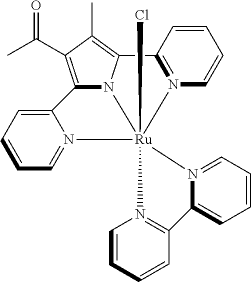

(1) cis-[Ru(dmso)₄(Cl)₂] (1.088 g, 2.248 mmol), 2,5-dipyridyl-3-methyl-4-acetylpyrrole (0.623 g, 2.248 mmol), bipyridine (0.351 g, 2.247 mmol) and a base were dissolved in an organic solvent (50 mL) under nitrogen atmosphere. The solution was stirred and heated to 100° C. and was reacted for 12 h.

(2) After the reaction was completed, toluene, diethyl ether and water were each added under nitrogen atmosphere to wash the mixture three times. Subsequently, the resulting solid was dissolved in dichloromethane, and anhydrous sodium sulfate was added to remove water from the solution. The solvent was removed from the filtrate to obtain a red solid.

(3) The resulting red solid was dissolved in dichloromethane by liquid phase diffusion, and diethyl ether and n-hexane were sequentially added. After the mixture was left to stand for 2 weeks, coordination complex 5 was obtained as a red acicular crystal.

Yield: 30%.

¹H NMR (400 MHz, CDCl₃): δ10.443-10.457 (d, 1H), δ8.906-8.927 (d, 1H), δ8.159-8.179 (d, 1H), δ7.913-7.932 (d, 1H), δ7.787-7.826 (t, 1H), δ7.709-7.722 (d, 1H), δ7.612-7.645 (t, 1H), δ7.454-7.505 (t, 1H), δ7.249-7.351 (m, 2H), δ7.087-7.110 (t, 2H), δ6.847-6.886 (m, 2H), δ6.406-6.475 (m, 2H), δ2.794 (s, 3H), δ2.603 (s, 3H).

IR (KBr, cm⁻¹): 3095 (w), 3059 (m), 1631 (m), 1589 (s), 1460 (s), 1417 (m), 1354 (w), 1340 (w), 1242 (w), 1136 (s), 1020 (w), 982 (w), 945 (w), 754 (m), 619 (w).

### 6. Gas Chromatography Experiments

(1) Gas chromatography was used to determine the gas composition during the reactions, and the conditions are as follows: the potential is not less than 0.5 V vs Cp₂Fe^{+/0}, and the electrolyte is an organic solution containing 0-0.1 mM coordination complex 1, 2, 3, 4 or 5, 0.1 M [NBu₄][PF₆], and 0-2.5 M NH₃.

(2) At different time stages of electrolysis, 100 μL of upper gas was drawn off with a gastight syringe and injected into a gas chromatograph to obtain the gas composition and content in the electrolytic cell.

The results are as follows: after 24 h of electrolysis, 375.4 μmol H₂ and 7.4 μmol N₂ were produced with coordination complex 1, 459.5 μmol H₂ and 6.32 μmol N₂ were produced with coordination complex 2, and 1458.35 μmol H₂ and 10.55 μmol N₂ were produced with coordination complex 3. After 48 h of electrolysis, 86.08 μmol H₂ and 5.85 μmol N₂ were produced with coordination complex 5. The gas chromatography experiments reveals that the ratio of H₂ to N₂ in the system ranges from 10:1 to 200:1, which is much higher than the ratio of hydrogen to nitrogen in an ammonia molecule (3:1). During the electrolysis, the positive electrode products were all NH₂NH₂ in addition to N₂, and no NO₂⁻, NO₃⁻ and the like were produced.

### 7. Ultraviolet-Visible Spectroscopy Experiments

(1) To a 10 mL cuvette, 0.4 mL of the electrolysis solution, 0.5 mL of HCl (0.6 mol/L) solution and 0.5 mL of p-C₉H₁₁NO in ethanol were added. The mixture was diluted with water to 10 mL and reacted for 1 h.

(2) 0.5 mL of the reaction mixture was diluted to 10 mL in a 10 mL cuvette. The absorption intensity at 455 nm was measured on an ultraviolet-visible spectrometer, and the NH₂NH₂ content in the electrolysis solution was obtained from the NH₂NH₂ concentration-455 nm absorbance standard curve through the measured intensity.

The results are as follows: after 24 h of electrolysis, 341.2 μmol, 423.0 μmol and 1380.04 μmol NH₂NH₂ were produced with coordination complexes 1, 2 and 3, respectively.

The main method of the present invention for preparing coordination complexes 1, 2, 3, 4 and 5 and the characteristics of electrocatalytic ammonia oxidation are shown and described above.

It will be understood by those skilled in the art that the present invention is not limited to the examples described above. The examples described above and the descriptions in the specification are only intended to illustrate the principles and procedures of the present invention. Various changes and improvements may be made to the present invention without departing from the spirit and scope of the present invention, and these changes and improvements all fall within the protection scope of the present invention. The protection scope of the present invention is defined by the appended claims and equivalents thereof.

What is claimed is:

1. A pyridine pyrrole ruthenium coordination complex, having a structure of any one of Formula 1 to Formula 5:

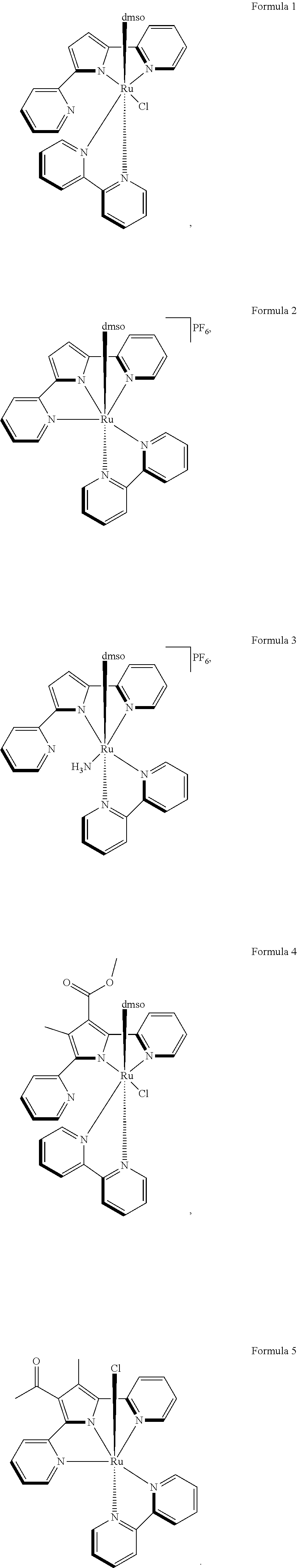

2. A method for synthesizing the pyridine pyrrole ruthenium coordination complex according to claim 1, comprising the following steps:
1) dissolving 2,5-dipyridylpyrrole, 2,5-dipyridyl-3-methyl-4-acetylpyrrole or 2,5-dipyridyl-3-carboxymethyl-4-methylpyrrole, cis-dichlorotetrakis(dimethyl sulfoxide)ruthenium, bipyridine and a basic compound in a solvent to provide a first resulting solution, and heating the first resulting solution to reflux and causing a first reaction to obtain the pyridine pyrrole ruthenium coordination complex having a structure of Formula 1, formula 4 or Formula 5; then optionally
2) dissolving the pyridine pyrrole ruthenium coordination complex having a structure of Formula 1 in a solvent to provide a second resulting solution, then first heating the second resulting solution to reflux and causing a second reaction, and then adding saturated ammonium hexafluorophosphate solution for ion exchange to obtain a pyridine pyrrole ruthenium coordination complex having a structure of Formula 2; and further optionally
3) dissolving the pyridine pyrrole ruthenium coordination complex having a structure of Formula 2 in a solvent to obtain a third resulting solution, and then introducing an ammonia-containing gas to the third resulting solution and causing a third reaction to obtain the pyridine pyrrole ruthenium coordination complex having a structure of Formula 3.

3. The method for synthesizing the pyridine pyrrole ruthenium coordination complex according to claim 2, wherein a molar ratio of 2,5-dipyridylpyrrole, 2,5-dipyridyl-3-methyl-4-acetylpyrrole or 2,5-dipyridyl-3-carboxymethyl-4-methylpyrrole to cis-dichlorotetrakis(dimethyl sulfoxide)ruthenium is 1:2 to 2:1.

4. The method for synthesizing the pyridine pyrrole ruthenium coordination complex according to claim 2, wherein a molar ratio of cis-dichlorotetrakis(dimethyl sulfoxide)ruthenium to bipyridine is 1:3 to 3:1.

5. The method for synthesizing the pyridine pyrrole ruthenium coordination complex according to claim 2, wherein the basic compound is at least one selected from the group consisting of calcium hydride, sodium hydride and triethylamine.

6. The method for synthesizing the pyridine pyrrole ruthenium coordination complex according to claim 2, wherein in step (1), the first reaction is performed at a temperature of 50-115° C. for a period of 8-12 h.

7. The method for synthesizing the pyridine pyrrole ruthenium coordination complex according to claim 2, wherein step (2) is performed, and in step (2) the second reaction is performed at a temperature of 50-115° C. for a period of 2-6 d.

8. The method for synthesizing the pyridine pyrrole ruthenium coordination complex according to claim 2, wherein steps (2) and (3) are performed, and in step (3) the ammonia-containing gas has an ammonia concentration of greater than 1%.

9. A method of using the pyridine pyrrole ruthenium coordination complex according to claim 1 as a catalyst for electrocatalyzing ammonia oxidation to prepare N₂H₄ and co-produce H₂, comprising the step of providing ammonia to the catalyst.

10. A method of using the pyridine pyrrole ruthenium coordination complex according to claim 1 as a catalyst for electrocatalyzing ammonia oxidation to prepare N₂H₄ and co-produce H₂, comprising the step of providing ammonia to the catalyst, wherein the catalyst is dissolved in an organic solvent selected from the group consisting of anhydrous tetrahydrofuran and anhydrous acetonitrile.
